(19) United States
(12) Patent Application Publication
(10) Pub. No.: US 2024/0400239 A1
(43) Pub. Date: Dec. 5, 2024

(54) Controller and Drone System

(71) Applicant: ACSL Ltd., Tokyo (JP)

(72) Inventor: Hisayoshi Kuroda, Tokyo (JP)

(21) Appl. No.: 18/700,136

(22) PCT Filed: Oct. 13, 2021
(86) PCT No.: PCT/JP2021/037910

§ 371 Date: Apr. 10, 2024

(51) Int. Cl. B64U 20/87; B64U 101/30

(52) U.S. Cl. CPC B64U 20/87; B64U 2101/30; B64U 2201/10; B64U 2201/20

(57) ABSTRACT

A controller as an example of the present disclosure has a body module including an operation machine that outputs an operation signal in response to an input of a user's operation for steering a drone provided with a first camera; and a transmission/reception module including a transmitter-receiver for transmitting the operation signal to the drone and for receiving, from the drone, a first video signal indicating a first video captured by the first camera, the transmission/reception module being separably joined to the body module.

### TECHNICAL FIELD

The present disclosure relates to a controller and a drone system.

### BACKGROUND ART

Various drone systems equipped with a drone and a controller for steering the drone have been studied recently. Conventional controllers integrally include an operation machine that outputs an operation signal in response to an input of a user's operation for steering a drone and a transmitter-receiver that communicates with the drone.

### CITATION LIST

### Patent Literature

Patent Literature 1: JP 2020-117129 A

### SUMMARY OF INVENTION

### Technical Problem

Since a conventional controller as described above integrally includes an operation machine and a transmitter-receiver, a user of the controller must be directly present within a communicable range of a drone to steer the drone. However, in a case where a potentially hazardous area is investigated, for example, a user should be in a safe position. For this reason, it is desired that a user can steer a drone without being directly present within a communicable range of the drone.

Thus, one of problems to be solved by the present disclosure is to provide a controller and a drone system by which a user can steer a drone without being directly present within a communicable range of the drone.

### Solution to Problem

A controller as an example of the present disclosure has: a body module including an operation machine that outputs an operation signal in response to an input of a user's operation for steering a drone provided with a first camera; and a transmission/reception module including a transmitter-receiver for transmitting the operation signal to the drone and for receiving, from the drone, a first video signal indicating a first video captured by the first camera, the transmission/reception module being separably joined to the body module.

A drone system as another example of the present disclosure has a drone provided with a first camera, and a controller of the drone, in which the controller has: a body module including an operation machine that outputs an operation signal in response to an input of a user's operation for steering a drone; and a transmission/reception module including a transmitter-receiver for transmitting the operation signal to the drone and for receiving, from the drone, a first video signal indicating a first video captured by the first camera, the transmission/reception module being separably joined to the body module.

### BRIEF DESCRIPTION OF DRAWINGS

FIG. 1 is an exemplary and schematic drawing illustrating an outer appearance of a controller, according to an embodiment.

FIG. 2 is an exemplary and schematic drawing illustrating an outer appearance of the controller according to the embodiment from a viewpoint opposite the viewpoint in FIG. 1.

FIG. 3 is an exemplary and schematic drawing illustrating a separation of a transmission/reception module from a body module according to the embodiment.

FIG. 4 is an exemplary and schematic drawing illustrating a cable connection part of the body module according to the embodiment.

FIG. 5 is an exemplary and schematic drawing illustrating a joining between the body module and the transmission/reception module according to the embodiment via a cable.

FIG. 6 is an exemplary and schematic block diagram illustrating an internal configuration of the controller and a drone when the body module and the transmission/reception module according to the embodiment are integrally joined to each other.

FIG. 7 is an exemplary and schematic block diagram illustrating an internal configuration of the controller and the drone when the body module and the transmission/reception module according to the embodiment are separated from each other.

FIG. 8 is an exemplary and schematic drawing illustrating an example of a display mode of videos on a display screen according to the embodiment.

FIG. 9 is an exemplary and schematic drawing illustrating an outer appearance of the controller according to a variation of the embodiment.

FIG. 10 is an exemplary and schematic drawing illustrating the transmission/reception module separated from the body module according to the variation of the embodiment.

FIG. 11 is an exemplary and schematic drawing illustrating cable connection parts of the body module and the transmission/reception module according to the variation of the embodiment.

### DESCRIPTION OF EMBODIMENTS

The embodiment of the controller and the drone system according to the present disclosure is described below on the basis of drawings. The configurations of the embodiment as well as actions and effects achieved by the configurations described below are simply examples and are not limited to those described below.

In the present disclosure, ordinal numerals such as “first” and “second” are used depending on necessity, but those ordinal numerals are used for convenience in distinguishment, not illustrating specific priority.

### EMBODIMENT

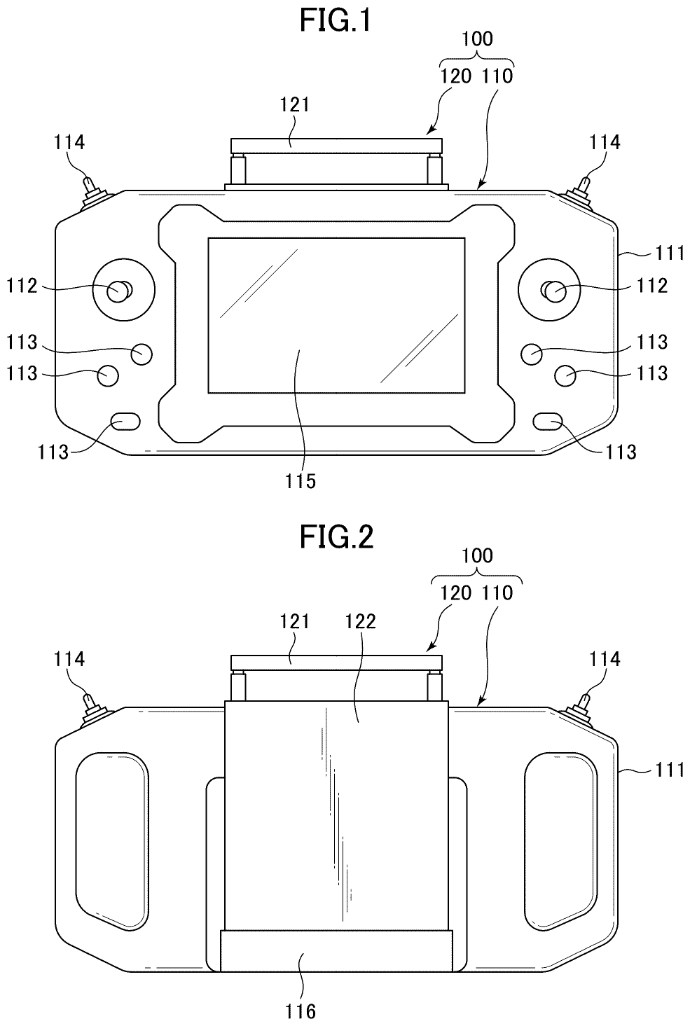

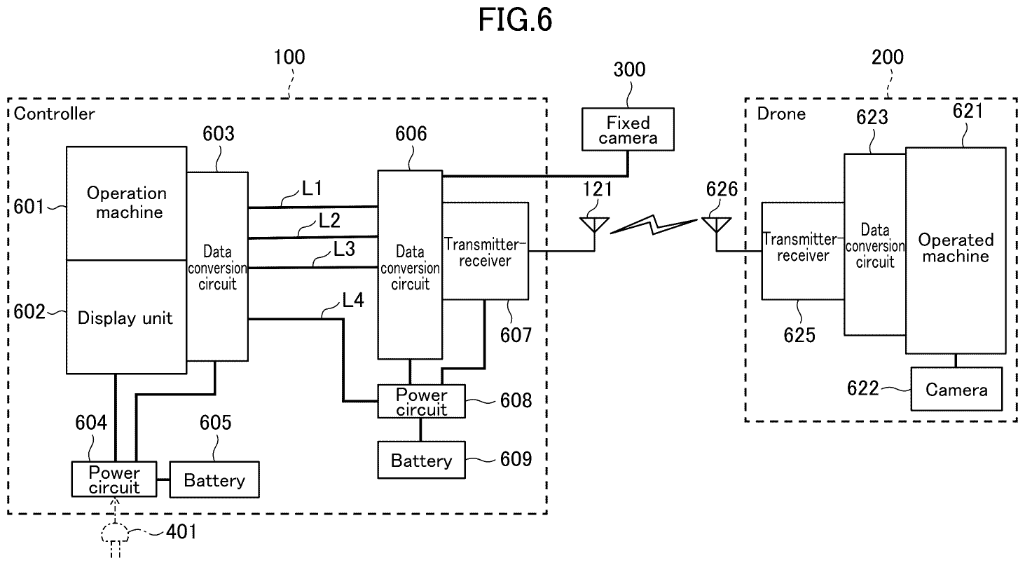

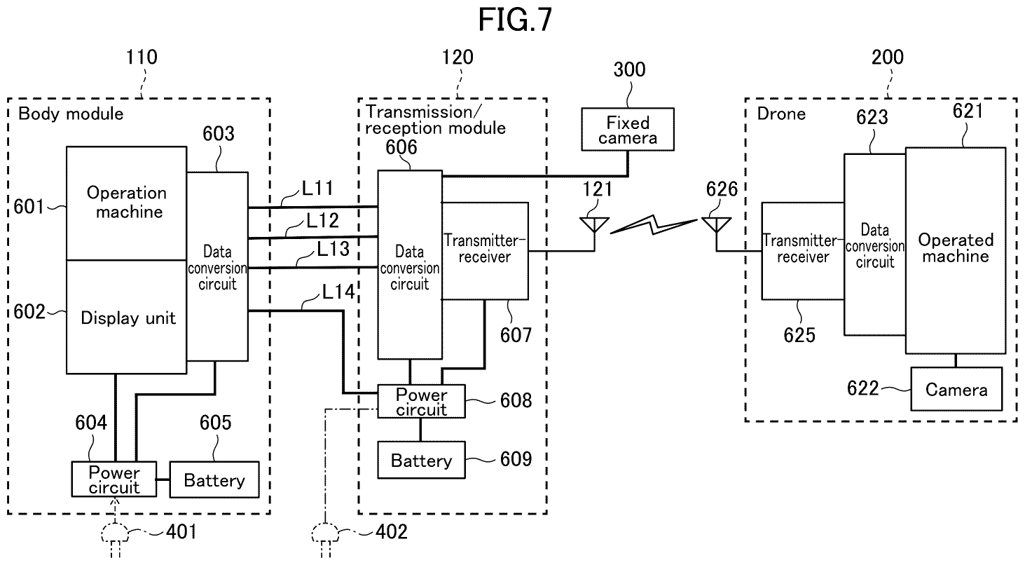

FIG. 1 is an exemplary and schematic drawing illustrating an outer appearance of a controller 100 according to the embodiment, and FIG. 2 is an exemplary and schematic drawing illustrating an outer appearance of the controller 100 according to the embodiment from a viewpoint opposite the viewpoint in FIG. 1. The controller 100 according to the embodiment is a steering machine such as a digital proportional type steering machine, for steering a drone 200 (cf. FIGS. 6 and 7) used for example in various types of investigations.

As illustrated in FIGS. 1 and 2, the controller 100 according to the embodiment includes a body module 110 and a transmission/reception module 120. The body module 110 includes a housing 111, an operation stick 112, a function button 113, a changeover switch 114, a display screen 115, and a slot part 116. The transmission/reception module 120 includes an antenna 121 and a housing 122.

The antenna 121 is provided to effectuate wireless communication with the drone 200 (cf. FIGS. 6 and 7). The housing 122 accommodates components of the transmission/reception module 120 (cf. FIGS. 6 and 7).

The housing 111 accommodates components of the body module 110 (cf. FIGS. 6 and 7). The operation stick 112 receives an input of a user's operation for steering the drone 200 (cf. FIGS. 6 and 7).

The function button 113 receives an input of a user's operation for performing various functions such as the power on/off of the controller 100, the on/off of the automatic flight of the drone 200, and the performing of video-capturing by the drone 200 (cf. FIGS. 6 and 7). The changeover switch 114 receives an input of a user's operation for changing the on/off of a predetermined flight mode such as collision avoidance by the drone 200, and the on/off of various operation modes, for example.

The display screen 115 is configured to be capable of displaying a video (or an image). Examples of videos displayed on the display screen 115 and the display modes of the videos will be described later, and hence are herein not described any further.

The slot part 116 is configured to receive a part of the transmission/reception module 120, more specifically an end opposite the antenna 121 of the housing 122 to be inserted into the slot part 116. Thereby, in the examples illustrated in FIGS. 1 and 2, the transmission/reception module 120 is inserted into the slot part 116 provided to the body module 110 to thereby be integrally joined to the body module 110. As a result, an electrical connection between the body module 110 and the transmission/reception module 120 is also ensured.

Here, in the examples illustrated in FIGS. 1 and 2, in which the body module 110 and the transmission/reception module 120 are integrally joined to each other, a user of the controller 100 must be directly present within a communicable range of the drone 200 (cf. FIGS. 6 and 7) to steer the drone 200. However, in a case where a potentially hazardous area is investigated, for example, a user should be in a safe position. For this reason, it is desired that a user can steer the drone 200 without being directly present within a communicable range of the drone 200.

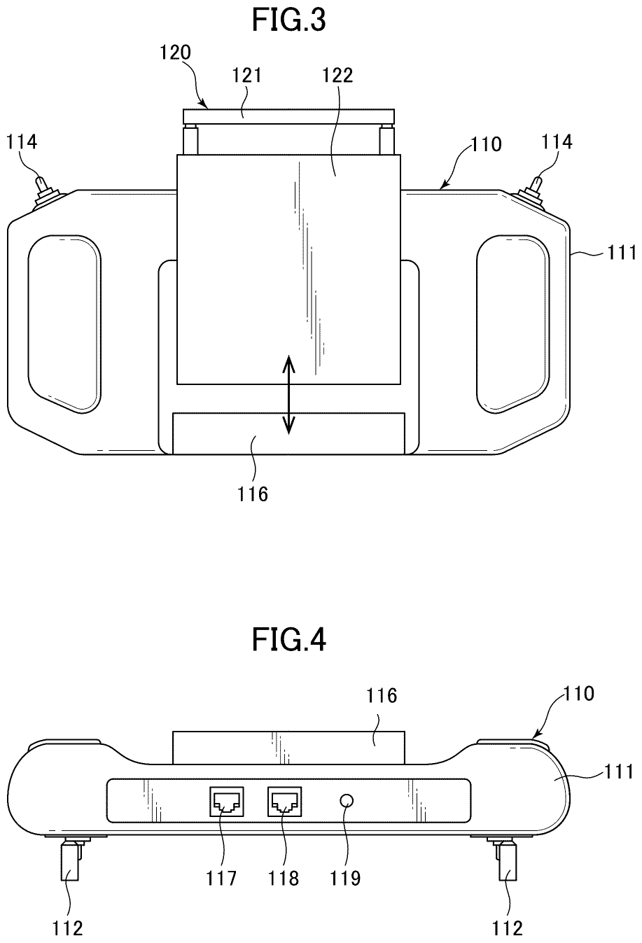

Then, in the embodiment, the body module 110 and the transmission/reception module 120 are configured to be separable from each other, for example, as illustrated in FIG. 3 below to allow a user to steer the drone 200 without being directly present within a communicable range of the drone 200 (cf. FIGS. 6 and 7).

FIG. 3 is an exemplary and schematic drawing illustrating the separation of the transmission/reception module 120 from the body module 110 according to the embodiment.

As illustrated in FIG. 3, in the embodiment, the transmission/reception module 120 is not fixedly but non-fixedly and appropriately separably joined to the body module 110 via the slot part 116. In other words, in the embodiment, the transmission/reception module 120 is separably joined to the body module 110 by being extractably inserted into the slot part 116 provided to the body module 110.

Here, even in a configuration in which the transmission/reception module 120 is separated from the body module 110, an electrical connection between the body module 110 and the transmission/reception module 120 must be ensured as with the configuration in which the transmission/reception module 120 is joined to the body module 110.

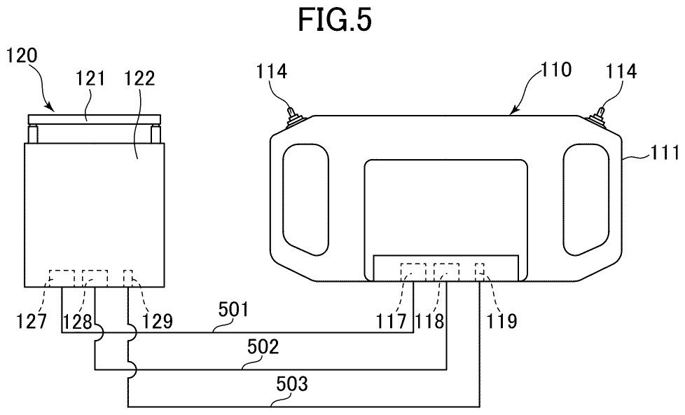

Then, in the embodiment, the body module 110 and the transmission/reception module 120 have a configuration of being joinable to each other via a plurality of cables 501, 502, and 503 even when both are separated from each other, as illustrated in FIGS. 4 and 5 below.

FIG. 4 is an exemplary and schematic drawing illustrating cable connection parts 117, 118, and 119 of the body module 110 according to the embodiment, and FIG. 5 is an exemplary and schematic drawing illustrating a joining between the body module 110 and the transmission/reception module 120 according to the embodiment via the cables 501 to 503.

As illustrated in FIG. 4, in the embodiment, the body module 110 includes three cable connection parts 117 to 119. In the example illustrated in FIG. 4, the cable connection parts 117 and 118 are configured to be connectable to an Ethernet cable (Ethernet is a registered tradename), and the cable connection part 119 is configured to be connectable to a DC cable.

As illustrated in FIG. 5, in the embodiment, the transmission/reception module 120 includes cable connection parts 127, 128, and 129 corresponding to the above cable connection parts 117, 118, and 119, respectively. In the embodiment, the cable connection part 117 is connected to the cable connection part 127 via the cable 501, the cable connection part 118 is connected to the cable connection part 128 via the cable 502, and the cable connection part 119 is connected to the cable connection part 129 via the cable 503.

In such a manner, in the embodiment, even in the configuration in which the transmission/reception module 120 is separated from the body module 110, the electrical connection between the body module 110 and the transmission/reception module 120 is ensured via the cables 501 to 503.

The examples illustrated in FIGS. 4 and 5 are simply examples. In the embodiment, cables other than Ethernet and DC cables, such as a USB (Universal Serial Bus) cable, are also usable.

In the examples illustrated in FIGS. 4 and 5, the number of the cable connection parts is three (thus, the number of cables is also three). The number “three” corresponds to the fact such that in the embodiment, three signals, i.e., an operation signal indicating a user's operation on the controller 100, a video signal indicating a video displayed on the display screen 115, and a power signal, can be transmitted between the body module 110 and the transmission/reception module 120. However, an operation signal, a video signal, and a power signal are collectively transmittable depending on necessity. Thus, in the embodiment, the number of the cable connection parts (and the number of cables) may be 2 or less as long as an operation signal, a video signal, and a power signal are appropriately transmitted.

On the basis of the above, the internal configuration of a drone system including the controller 100 and the drone 200 according to the embodiment is more specifically described.

FIG. 6 is an exemplary and schematic block diagram illustrating internal configurations of the controller 100 and the drone 200 when the body module 110 and the transmission/reception module 120 according to the embodiment are integrally joined to each other.

As illustrated in FIG. 6, the drone 200 according to the embodiment includes an operated machine 621, a camera 622, a data conversion circuit 623, and a transmitter-receiver 625. The camera 622 is an example of the “first camera” in the present disclosure.

The operated machine 621 includes devices such as a processor, a memory, and an actuator that control the flight of the drone 200 in response to a user's operation on the controller 100. The camera 622 captures a video from a viewpoint of the drone 200.

The data conversion circuit 623 performs signal processing that is necessary for the transmission and reception of a variety of data signals between the transmitter-receiver 625 and the operated machine 621. For example, the data conversion circuit 623 converts a signal output from the transmitter-receiver 625 into a form being processable by the operated machine 621 or converts a video input from the camera 622 via the operated machine 621 into a form being processable by the transmitter-receiver 625. The transmitter-receiver 625 transmits and receives a wireless signal to and from the controller 100 via an antenna 626.

As described above, the example illustrated in FIG. 6 shows the case in which the body module 110 and the transmission/reception module 120 are integrally joined to each other. Thus, in the example illustrated in FIG. 6, the controller 100 integrally includes an operation machine 601, a display unit 602, a data conversion circuit 603, a power circuit 604, a battery 605, a data conversion circuit 606, a transmitter-receiver 607, a power circuit 608, and a battery 609.

For example, the operation machine 601 includes devices such as a processor that outputs an operation signal in response to an input of a user's operation (such as the operation of the operation sticks 112, the function buttons 113, or the changeover switches 114 as illustrated in FIG. 1) for steering the drone 200, and a memory. The display unit 602 includes for example devices such as a processor that controls an output of a video onto the display screen 115 (cf. FIG. 1) and a memory. In the embodiment, the display unit 602 is configured to be capable of displaying at least one of a first video and a second video on the display screen 115, the first video being captured by the camera 622 of the drone 200 and the second video being captured by a fixed camera 300 fixedly provided to capture an area where the drone 200 is taking off or landing. The fixed camera 300 is an example of the “second camera” in the present disclosure.

The data conversion circuit 603 performs signal processing that is necessary for transmitting and receiving a variety of data signals between the operation machine 601 and the display unit 602, and signal lines L1, L2, and L3. The data conversion circuit 603 is connected to the data conversion circuit 606 via the signal lines L1 to L3 and is connected to the power circuit 608 via a power line L4.

The power circuit 604 receives power supply from an external power source 401 and supplies power to the operation machine 601, the display unit 602, the data conversion circuit 603, and the battery 605. The battery 605 accumulates power supplied from the power circuit 604 and if needed, supplies the accumulated power to the operation machine 601, the display unit 602, and the data conversion circuit 603 via the power circuit 604.

The data conversion circuit 606 performs signal processing that is necessary for transmitting and receiving a variety of data signals between the signal lines L1 to L3 and the transmitter-receiver 607. In the example illustrated in FIG. 6, the data conversion circuit 606 is also configured to serve as an acquisition unit for acquiring a second video signal indicating a second video captured by the fixed camera 300 through a channel different from that employed by the transmitter-receiver 607. In the embodiment, however, a second video signal may also be acquired via the transmitter-receiver 607.

The transmitter-receiver 607 transmits and receives wireless signals to and from the drone 200 via the antenna 121. The power circuit 608 receives power supply from the power line L4 and supplies power to the data conversion circuit 606, the transmitter-receiver 607, and the battery 609. The battery 609 accumulates power supplied from the power circuit 608 and supplies the accumulated power to the data conversion circuit 606 and the transmitter-receiver 607 via the power circuit 608, depending on necessity.

In the example illustrated in FIG. 6, the signal line L1 is a line for transmitting an operation signal. The signal line L2 is a line for transmitting a first video signal indicating a first video captured by the camera 622 of the drone 200, and the signal line L3 is a line for transmitting a second video signal indicating a second video captured by the fixed camera 300 that is fixedly provided to capture an area where the drone 200 is taking off or landing. The power line L4 is a line for transmitting power. These signal lines L1 to L3 and the power line L4 can be expressed as internal wiring configured in the controller 100 by the body module 110 and the transmission/reception module 120 integrally joining to each other via the slot part 116 (cf. FIGS. 1 and 2).

FIG. 7 is an exemplary and schematic block diagram illustrating internal configurations of the controller 100 and the drone 200 when the body module 110 and the transmission/reception module 120 according to the embodiment are separated from each other. Only the differences from FIG. 6 will be described in detail below.

As described above, an electrical connection between the body module 110 and the transmission/reception module 120 can be ensured via the above-described cables 501 to 503 (cf. FIG. 5) even when the body module 110 and the transmission/reception module 120 are separated from each other. In this case, as illustrated in FIG. 7, the body module 110 including the operation machine 601, the display unit 602, the data conversion circuit 603, the power circuit 604, and the battery 605, and the transmission/reception module 120 including the data conversion circuit 606, the transmitter-receiver 607, the power circuit 608, and the battery 609, both physically separated from each other, are electrically connected via the signal lines L11, L12, and L13, and the power line L14. The signal lines L11 to L13 and the power line L14 can be expressed as cable internal wiring provided inside the above cables 501 to 503. The signal lines L11 to L13 and the power line L14 each transmit the same information as that transmitted via the signal lines L1 to L3 and the power line L4 illustrated in FIG. 6.

As illustrated in FIG. 7, the transmission/reception module 120 is configured to be capable of receiving power supply from the external power source 402 via the power circuit 608 depending on necessity, when separated from the body module 110, even without power supply from the body module 110 via the power line L14. Thereby the operation of the transmission/reception module 120 can be stabilized. In the embodiment, a structure for fixing in a predetermined position using for example a magnet, sticky tape, or a tripod may be provided to the transmission/reception module 120 to increase convenience in operating the transmission/reception module 120 separated from the body module 110.

Here, as illustrated in FIGS. 6 and 7, in the embodiment, the two types of videos that can be displayed by the display unit 602 on the display screen 115 (cf. FIG. 1) are a first video captured by the camera 622 of the drone 200 and a second video captured by the fixed camera 300 that is fixedly provided to capture an area where the drone 200 is taking off or landing. Upon taking off or landing of the drone 200, it is beneficial to allow a user to confirm the two types of videos simultaneously.

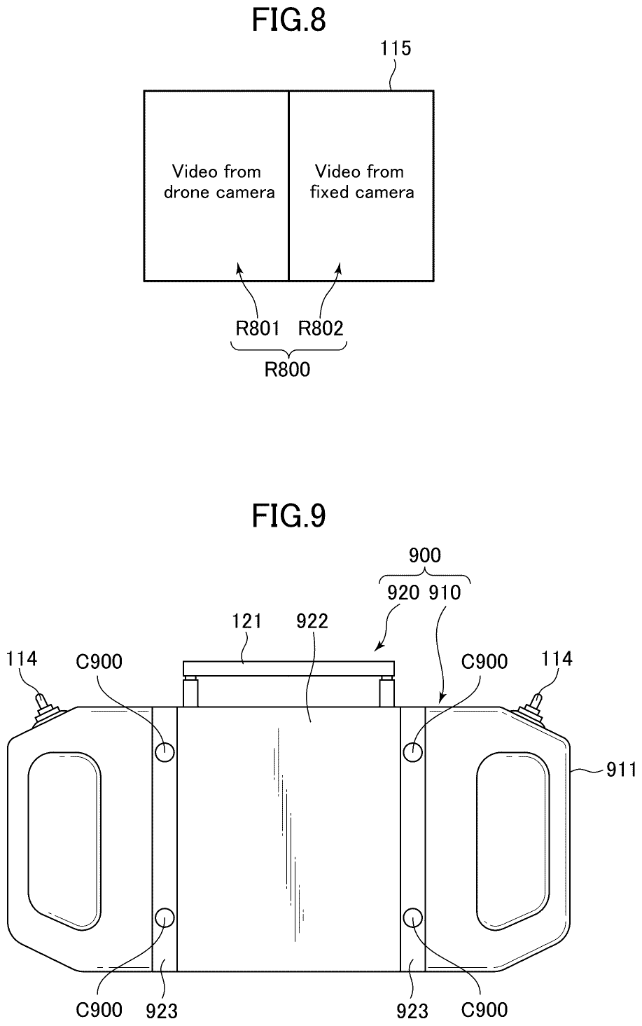

Then, the display unit 602 according to the embodiment can simultaneously display both the above first video and second video on the display screen 115, for example in a display mode as illustrated in FIG. 8 below.

FIG. 8 is an exemplary and schematic drawing illustrating an example of a display mode of videos on the display screen 115 according to the embodiment.

As illustrated in FIG. 8, in the embodiment, the display area R800 over the entirety of the display screen 115 may be equally divided into two areas of a first area R801 and a second area R802. On the first area R801 on the left side, a video from the camera 622 of the drone 200, namely a first video, may be displayed and simultaneously on the second area R802 on the right side, a video from the fixed camera 300, namely a second video, may be displayed. Thereby a user can confirm the two types of videos simultaneously.

In the example illustrated in FIG. 8, the display area R800 is divided into left and light sections, but in the embodiment, the display area R800 may be divided into upper and lower sections. In the example illustrated in FIG. 8, the display area R800 is equally divided, but in the embodiment, the display area R800 need not be equally divided. In the embodiment, the division mode of the display area R800 may be appropriately determined or changed by a user.

In the embodiment, when a flight path plan including a taking-off section or a landing section is set for the drone 200, the simultaneous display of the two types of videos illustrated in FIG. 8 may be automatically performed in accordance with said flight path plan. For example, in the embodiment, the flight path plan for the drone 200 can be set in the operated machine 621 of the drone 200 and/or the operation machine 601 of the body module 110 of the controller 100. In this case, if a simultaneous display instruction for the display unit 602 to simultaneously display the two types of videos as illustrated in FIG. 8 is associated with the taking off section or the landing section of the flight path plan, the display unit 602 can automatically perform simultaneous display in response to said simultaneous display instruction being input, for example, from the operation machine 601, during a period in which the taking-off section or the landing section is performed.

As described above, the controller 100 of the drone system according to the embodiment includes the body module 110 and the transmission/reception module 120. The body module 110 includes the operation machine 601 that outputs an operation signal in response to an input of a user's operation for steering the drone 200 provided with the camera 622. The transmission/reception module 120 includes the transmitter-receiver 607 that transmits an operation signal to the drone 200 and receives from the drone 200 a first video signal indicating a first video captured by the camera 622. The transmission/reception module 120 is separably joined to the body module 110.

Since the transmission/reception module 120 communicating with the drone 200 can be operated at a distance from a user operating the body module 110 according to the above configuration, the user can steer the drone 200 without being directly present within a communicable range of the drone 200.

In the embodiment, the transmission/reception module 120 is, when separated from the body module 110, connected to the body module 110 via the cables 501 and 502 that transmit an operation signal and a first video signal.

According to the above embodiment, an (electrical) connection between the body module 110 and the transmission/reception module 120 can be easily ensured using the cables 501 and 502 even when the body module 110 and the transmission/reception module 120 are separated from each other.

In the embodiment, the transmission/reception module 120 includes the data conversion circuit 606 that serves as an acquisition unit for acquiring a second video signal indicating a second video captured by the fixed camera 300 fixedly provided to capture an area where the drone 200 is taking off or landing. The body module 110 includes the display unit 602 that displays at least one of a first video based on a first video signal and a second video based on a second video signal on the display screen 115.

According to the above configuration, information that is beneficial in steering the drone 200 can be visually provided to the user by utilizing at least one of a first video and a second video.

In the embodiment, the display unit 602 displays a first video in a first area R801 on the display screen 115 and simultaneously displays a second video in a second area R802 that is different from the first area R801 on the display screen 115. Thereby the display unit 602 can display both the first video and the second video simultaneously on the display screen 115.

According to the above configuration, a user can simultaneously confirm two types of videos, i.e., the first video and the second video. Thereby the user can steer the drone 200 while simultaneously confirming a situation by means of the first video from a viewpoint of the drone 200 and a situation by means of a second video of an area where the drone 200 is taking off or landing, even when the user cannot see the area where the drone 200 is taking off or landing. As a result, the drone 200 can safely take off or land during what is called a flight beyond visual line of sight.

In the embodiment, when a flight path plan including a taking-off section or a landing section is set for the drone 200, the display unit 602 can simultaneously display both the first video and the second video on the display screen during a period in which the taking-off section or the landing section is performed, in response to a simultaneous display instruction associated with the taking-off section or the landing section.

According to the above configuration, the simultaneous display of the first video and the second video can be automatically performed at an appropriate timing in response to the simultaneous display instruction associated with the taking-off section or the landing section.

In the embodiment, the transmission/reception module 120 is separably joined to the body module 110 by being extractably inserted into the slot part 116 provided to the body module 110.

According to the above configuration, the body module 110 and the transmission/reception module 120 can be easily joined to or separated from each other by inserting or pulling out the transmission/reception module 120 into or from the slot part 116 provided to the body module 110.

### Variation

The above embodiment exemplifies a configuration in which the body module 110 and the transmission/reception module 120 are joined to or separated from each other by inserting or pulling out the transmission/reception module 120 into or from the slot part 116 provided to the body module 110. As a variation, however, a configuration in which the body module 910 and the transmission/reception module 920 are joined to or separated from each other by the structures illustrated in FIGS. 9 to 11 below is also considered.

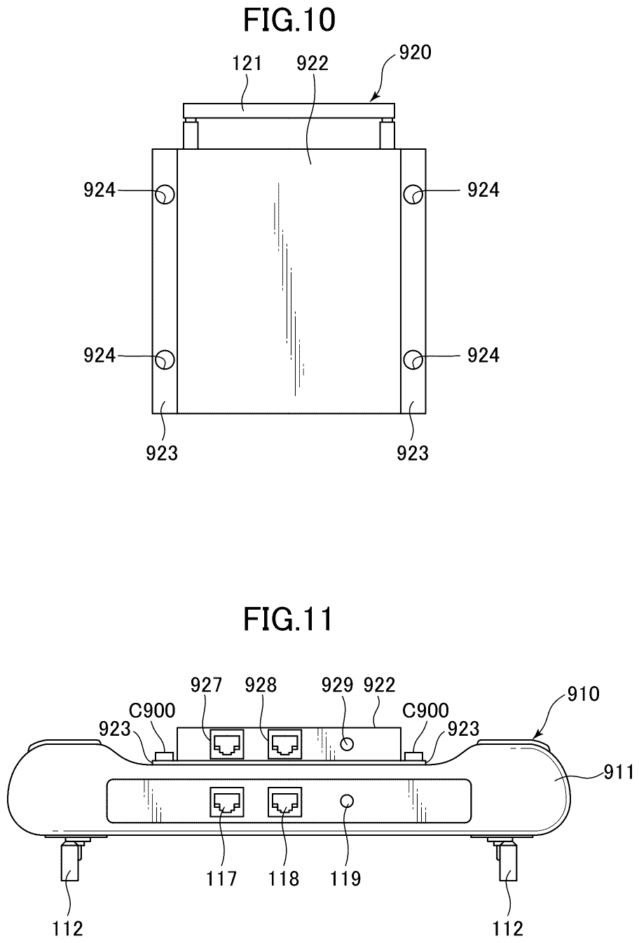

FIG. 9 is an exemplary and schematic drawing illustrating an outer appearance of a controller 900 according to a variation of the embodiment. FIG. 10 is an exemplary and schematic drawing illustrating the transmission/reception module 920 separated from the body module 910 according to the variation of the embodiment. FIG. 11 is an exemplary and schematic drawing illustrating cable connection parts 117, 118, 119, 927, 928, and 929 of the body module 910 and the transmission/reception module 920 according to the variation of the embodiment. In this variation, the same components as those employed in the above embodiment are represented by the same reference signs as those used in the embodiment, and the detailed descriptions thereof are omitted.

In this variation, the body module 910 and the transmission/reception module 920 are separably joined to each other via a removable joining tool C900, as illustrated in FIGS. 9 and 11. Thus, in this variation, a through hole 924 into which the joining tool C900 is inserted is provided on a flange part 923 that is provided to a housing 922 of the transmission/reception module 920, as illustrated in FIG. 10. The joining tool C900 is for example a screw component such as a bolt.

Here, in this variation, an electrical connection between the body module 910 and the transmission/reception module 920 is not ensured merely by joining the body module 910 and the transmission/reception module 920 to each other via the joining tools C900.

Then, in this variation, all the cable connection parts 117, 118, and 119 provided to the body module 910, and the cable connection parts 927, 928, and 929 provided on the transmission/reception module 920 are exposed when the body module 910 and the transmission/reception module 920 are joined to each other, as illustrated in FIG. 11. Thereby, in this variation, an electrical connection between the body module 910 and the transmission/reception module 920 is ensured by connecting the cable connection parts 117, 118, and 119 and the cable connection parts 927, 928, and 929 via cables (not illustrated), respectively, regardless of whether the body module 910 and the transmission/reception module 920 are joined to or separated from each other.

In other words, in this variation, when the body module 910 and the transmission/reception module 920 are joined to each other, the cable connection parts 117, 118, and 119 are each connected to the cable connection parts 927, 928, and 929, respectively, via relatively short cables (not illustrated). In contrast, when the body module 910 and the transmission/reception module 920 are separated from each other, the cable connection parts 117, 118, and 119 are each connected to the cable connection parts 927, 928, and 929, respectively, via relatively long cables (not illustrated).

According to the above variation also, the transmission/reception module 920 communicating with the drone 200 can also be operated at a distance from a user operating the body module 910 as with the above embodiment. Thus, the user can steer the drone 200 without being directly present within a communicable range of the drone 200.

The embodiment and variation of the present disclosure are described above. These embodiment and variation are provided as examples which are not intended to restrict the scope of the invention. These novel embodiment and variation can be performed in various other modes, and can be subjected to various omissions, replacements, and modifications as long as they do not deviate from the gist of the invention. These embodiment and variation are included in the scope of the invention or the gist of the invention, as well as in the invention described in claims and in the equivalent scope thereof.

### REFERENCE SIGNS LIST

100, 900 Controller
110, 910 Body module
115 Display screen
116 Slot part
120, 920 Transmission/reception module
200 Drone
300 Fixed camera (second camera)
601 Operation machine
602 Display unit
606 Data conversion circuit (acquisition unit)
607 Transmitter-receiver
622 Camera (first camera)
501, 502, 503 Cable
C900 Joining tool

1. A controller comprising
a body module including an operation machine that outputs an operation signal in response to an input of a user's operation for steering a drone provided with a first camera, and
a transmission/reception module including a transmitter-receiver for transmitting the operation signal to the drone and for receiving, from the drone, a first video signal indicating a first video captured by the first camera, the transmission/reception module being separably joined to the body module.

2. The controller of claim 1,
wherein the transmission/reception module is, when separated from the body module, connected to the body module via a cable that transmits the operation signal and the first video signal.

3. The controller of claim 1,
wherein the transmission/reception module includes an acquisition unit that acquires a second video signal indicating a second video captured by a second camera fixedly provided to capture an area where the drone is taking off and landing, and
wherein the body module includes a display unit that displays at least one of the first video based on the first video signal and the second video based on the second video signal on a display screen.

4. The controller of claim 3,
wherein the display unit displays the first video in a first area on the display screen and displays the second video in a second area that is different from the first area on the display screen to display both the first video and the second video simultaneously on the display screen.

5. The controller of claim 4,
wherein, when a flight path plan including a taking-off section or a landing section is set for the drone, the display unit displays both the first video and the second video simultaneously on the display screen during a period in which the taking-off section or the landing section is performed, in response to a simultaneous display instruction associated with the taking-off section or the landing section.

6. The controller of claim 3,
wherein the transmission/reception module is separably joined to the body module by being extractably inserted into a slot part provided to the body module.

7. The controller of claim 1,
wherein the transmission/reception module is separably joined to the body module via a removable joining tool.

8. A drone system comprising
a drone provided with a first camera, and
a controller of the drone,
wherein the controller comprises
a body module including an operation machine that outputs an operation signal in response to an input of a user's operation for steering the drone, and
a transmission/reception module including a transmitter-receiver for transmitting the operation signal to the drone and for receiving, from the drone, a first video signal indicating a first video captured by the first camera, the transmission/reception module being separably joined to the body module.

9. The drone system of claim 8,
wherein the transmission/reception module is, when separated from the body module, connected to the body module via a cable that transmits the operation signal and the first video signal.

10. The drone system of claim 8,
wherein the transmission/reception module includes an acquisition unit that acquires a second video signal indicating a second video captured by a second camera fixedly provided to capture an area where the drone is taking off and landing, and
wherein the body module includes a display unit that displays at least one of the first video based on the first video signal and the second video based on the second video signal on a display screen.

11. The drone system of claim 10,
wherein the display unit displays the first video in a first area on the display screen and displays the second video in a second area that is different from the first area on the display screen to display both the first video and the second video simultaneously on the display screen.

12. The drone system of claim 11,
wherein, when a flight path plan including a taking-off section or a landing section is set for the drone, the display unit displays both the first video and the second video simultaneously on the display screen during a period in which the taking-off section or the landing section is performed, in response to a simultaneous display instruction associated with the taking-off section or the landing section.

13. The drone system of claim 10,
wherein the transmission/reception module is separably joined to the body module by being extractably inserted into a slot part provided to the body module.

14. The drone system of claim 8,
wherein the transmission/reception module is separably joined to the body module via a removable joining tool.
